(19) United States
(12) Patent Application Publication
(10) Pub. No.: US 2026/0277050 A1
(43) Pub. Date: Sep. 17, 2026

(54) DISPLAY PANEL

(71) Applicant: HannStar Display Corporation, Taipei City (TW)

(72) Inventors: Jing-Ya Chiu, Taipei City (TW); Qi-En Luo, Taipei City (TW); Ying-Jung Chen, Taipei City (TW); Shao-Chien Chang, Taipei City (TW); Ling Chih Kao, Taipei City (TW); Cheng-Yen Yeh, Taipei City (TW)

(73) Assignee: HannStar Display Corporation, Taipei City (TW)

(21) Appl. No.: 19/346,450

(22) Filed: Sep. 30, 2025

(30) Foreign Application Priority Data
Mar. 13, 2025 (TW) 114109293

(51) Int. Cl. G02F 1/1335; G02F 1/1333; G02F 1/1343

(52) U.S. Cl. CPC G02F 1/133553; G02F 1/133345; G02F 1/133512; G02F 1/134309

(57) ABSTRACT

A display panel including a first substrate, a second substrate, a liquid crystal layer, a pixel structure and a first insulation layer is provided. The liquid crystal layer is disposed between the first substrate and the second substrate along a first direction. The pixel structure has a reflective area and a transmissive area. The pixel structure includes a reflective layer located in the reflective area and a pixel electrode located in the transmissive area. The first insulation layer is disposed between the liquid crystal layer and the second substrate and has a first groove located in the transmissive area. The liquid crystal layer has a first portion overlapping the first groove and a second portion overlapping the reflective layer. A first thickness of the first portion along the first direction is greater than a second thickness of the second portion along the first direction.

### CROSS-REFERENCE TO RELATED APPLICATION

This application claims the priority benefit of Taiwan application serial no. 114109293, filed on March 13, 2025. The entirety of the above-mentioned patent application is hereby incorporated by reference herein and made a part of this specification.

### BACKGROUND

### Technical Field

The disclosure relates to a display technology, and in particular, to a display panel.

### Description of Related Art

Since transflective display panels maintain good readability both indoors and outdoors while offering energy-saving benefits, they have secured a position in the market. In the existing transflective display architectures, display pixels are required to include both reflective and transmissive areas to meet display requirements under varying ambient light conditions (e.g., insufficient or excessive ambient light). However, the optical path lengths of light in the liquid crystal layer differ significantly between the reflective area and the transmissive area, resulting in inconsistent display performance (e.g., display brightness and color performance), which affects the user's viewing experience.

### SUMMARY

The disclosure provides a display panel with more uniform display performance between the transmissive area and the reflective area and enhanced display contrast.

A display panel of the disclosure includes a first substrate, a second substrate, a liquid crystal layer, a pixel structure and a first insulation layer. The first substrate and the second substrate are stacked along a first direction. The liquid crystal layer is disposed between the first substrate and the second substrate. The pixel structure is disposed on the first substrate and has a reflective area and a transmissive area. The pixel structure includes a reflective layer and a pixel electrode. The reflective layer is located in the reflective area. The pixel electrode is located in the transmissive area. The first insulation layer is disposed between the liquid crystal layer and the second substrate and has a first groove located in the transmissive area. The liquid crystal layer has a first portion overlapping the first groove and a second portion overlapping the reflective layer. A first thickness of the first portion along the first direction is greater than a second thickness of the second portion along the first direction.

In an embodiment of the disclosure, a ratio of the first thickness to the second thickness of the display panel is 2.

In an embodiment of the disclosure, the first insulation layer of the display panel further includes a first insulation portion and a second insulation portion. The first insulation portion is located in the transmissive area and has a first insulation thickness along the first direction. The second insulation portion is located in the reflective area and has a second insulation thickness along the first direction. The second insulation thickness is greater than the first insulation thickness.

In an embodiment of the disclosure, the display panel further includes a light shielding pattern disposed on the second substrate. The first insulation layer further has a side surface surrounding and defining the first groove. The side surface of the first insulation layer overlaps the light shielding pattern.

In an embodiment of the disclosure, the first insulation layer of the display panel further has a side surface surrounding and defining the first groove. The side surface of the first insulation layer overlaps the reflective layer.

In an embodiment of the disclosure, the display panel further includes a second insulation layer disposed between the pixel electrode and the first substrate and has a second groove located in the transmissive area. The first groove overlaps the second groove.

In an embodiment of the disclosure, the first groove and the second groove of the display panel have a first depth and a second depth respectively. A ratio of the first depth to the second depth is greater than or equal to 0.8 and less than or equal to 1.2.

In an embodiment of the disclosure, the first insulation layer of the display panel further has a first side surface surrounding and defining the first groove. The second insulation layer further has a second side surface surrounding and defining the second groove. The first portion of the liquid crystal layer has a third thickness overlapping the first side surface and the second side surface along a second direction. The second direction is not parallel to and not perpendicular to the first direction. A ratio of the third thickness to the second thickness is 2.

In an embodiment of the disclosure, the display panel further includes a metal layer disposed on the first substrate. The second insulation layer further has a side surface surrounding and defining the second groove. The side surface of the second insulation layer overlaps the metal layer.

In an embodiment of the disclosure, the pixel electrode of the display panel is also located in the reflective area. The pixel electrode overlaps the reflective layer and is electrically connected to the reflective layer.

Based on the above, in a display panel according to an embodiment of the disclosure, the pixel structure is provided with a reflective area and a transmissive area. Since the insulation layer disposed between the second substrate and the common electrode layer has a groove located in the transmissive area, the thickness of the liquid crystal layer in the transmissive area is greater than the thickness of the liquid crystal layer in the reflective area. Therefore, the optical path difference of light in the liquid crystal layer between the reflective area and the transmissive area can be effectively reduced, thereby improving the uniformity of display performance of the display panel in the reflective area and the transmissive area.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1 is a schematic front view of a display panel according to an embodiment of the disclosure.

FIG. 2 is a schematic cross-sectional view of the display panel of FIG. 1.

FIG. 3 is a schematic cross-sectional view of a display panel according to another embodiment of the disclosure.

### DESCRIPTION OF THE EMBODIMENTS

The aforementioned technical contents, features and effects of the disclosure will be clearly presented in the following detailed description of a preferred embodiment with reference to the drawings. The directional terms used in the following embodiments, such as up, down, left, right, front, or rear, are for reference to the directions indicated in the accompanying drawings. Therefore, these directional terms are used for explanation purposes and not for limiting the scope of the invention.

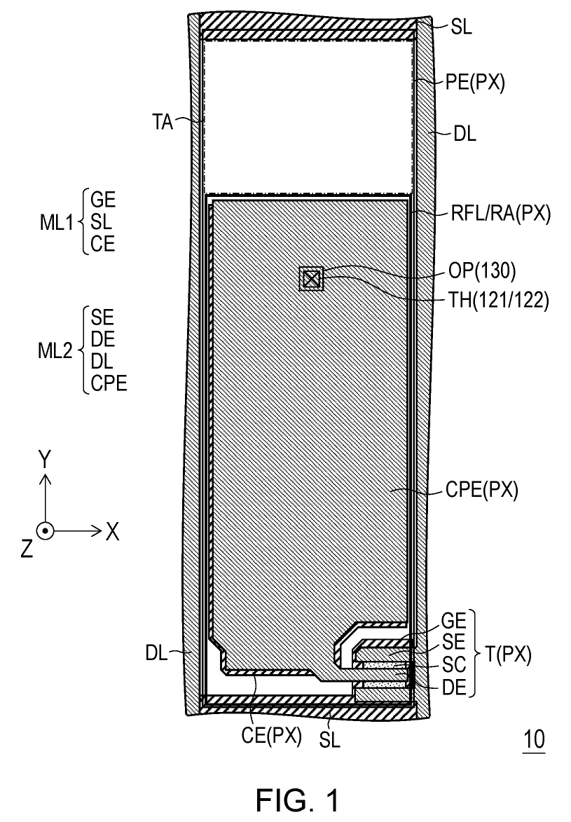

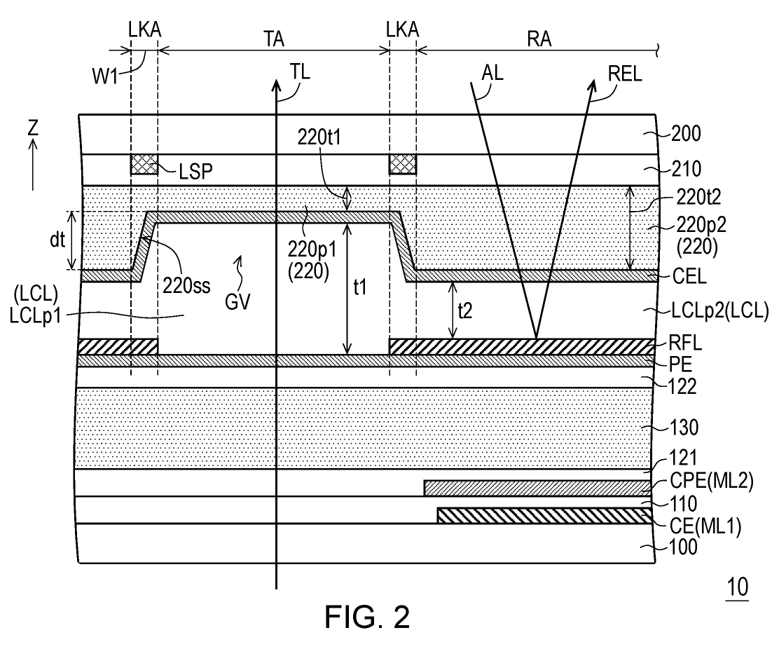

FIG. 1 is a schematic front view of a display panel according to an embodiment of the disclosure. FIG. 2 is a schematic cross-sectional view of the display panel of FIG. 1. For clarity, FIG. 1 only illustrates a portion of the film layers in FIG. 2.

Referring to FIG. 1 and FIG. 2, a display panel 10 includes a first substrate 100, a second substrate 200 and a liquid crystal layer LCL. The first substrate 100 and the second substrate 200 may be stacked along a direction Z. The liquid crystal layer LCL is disposed between the first substrate 100 and the second substrate 200. That is, the display panel 10 of the embodiment is a liquid crystal display panel, but the disclosure is not limited thereto.

In the embodiment, a plurality of scan lines SL, a plurality of data lines DL and a plurality of pixel structures PX may be disposed on the first substrate 100. The pixel structure PX is electrically connected to a scan line SL and a data line DL. It should be noted that FIG. 1 only illustrates one display pixel of the display panel 10, and the display panel 10 may include a plurality of display pixels arranged in an array. For example, the plurality of data lines DL may be arranged along a direction X and each extend in a direction Y, and the plurality of scan lines SL may be arranged along the direction Y and each extend in the direction X, wherein the direction X is not parallel to direction Y. The direction X may be selectively perpendicular to the direction Y, but the disclosure is not limited thereto. The plurality of pixel structures PX may be arranged in a plurality of rows and a plurality of columns along the direction X and the direction Y, respectively.

In the embodiment, the pixel structure PX includes an active device T, a common electrode CE, a capacitor electrode CPE, a pixel electrode PE and a reflective layer RFL. The active device T has a source electrode SE, a drain electrode DE, a gate electrode GE and a semiconductor pattern SC. The source electrode SE is electrically connected to a corresponding data line DL. The drain electrode DE is electrically connected to the capacitor electrode CPE. The gate electrode GE is electrically connected to a corresponding scan line SL. More specifically, an extension portion of the scan line SL corresponding to the pixel structure PX may serve as the gate electrode GE of the active device T, and an extension portion of the data line DL corresponding to the pixel structure PX may serve as the source electrode SE of the active device T. The material of the semiconductor pattern SC may include an amorphous silicon semiconductor, a single crystal silicon semiconductor, a polycrystalline silicon semiconductor, or a metal oxide semiconductor. In the embodiment, the active device T is, for example, an amorphous silicon thin film transistor (a-Si TFT), but the disclosure is not limited thereto. In other embodiments, the active device T may also be a polycrystalline silicon thin film transistor (poly-Si TFT) or a metal oxide semiconductor TFT. In addition, in the embodiment, the gate electrode GE may be selectively disposed under the semiconductor pattern SC to form a bottom-gate TFT, but the disclosure is not limited thereto. In other embodiments, the gate electrode GE may be disposed above the semiconductor pattern SC to form a top-gate TFT. The capacitor electrode CPE extends from the drain electrode DE and is electrically connected to the pixel electrode PE. The pixel electrode PE is electrically connected to the capacitor electrode CPE via an opening OP of an insulation layer 130 and a through hole TH of a first passivation layer 121 and a second passivation layer 122.

In the embodiment, the pixel electrode PE is a light-transmissive electrode. The light-transmissive electrode may be composed of a transparent conductive material. For example, the material of the light-transmissive electrode includes metal oxides, such as indium tin oxide, indium zinc oxide, aluminum tin oxide, aluminum zinc oxide, or other suitable oxides, or a stacked layer of at least two of the above. For consideration of conductivity, the scan line SL, the data line DL, the capacitor electrode CPE, the common electrode CE, and the source electrode SE, the drain electrode DE, and the gate electrode GE of the active device T are typically made of metal materials, but the disclosure is not limited thereto.

The common electrode CE is disposed between the capacitor electrode CPE and the first substrate 100, and overlaps the capacitor electrode CPE along the direction Z. If not specifically mentioned below, the overlapping relationship between two components is defined along the direction Z, and the overlapping direction will not be described in detail. In the embodiment, the common electrode CE may be electrically coupled to the capacitor electrode CPE to form a storage capacitor. More specifically, the storage capacitor is formed by the common electrode CE, the capacitor electrode CPE, and the insulation layer 110 located between the common electrode CE and the capacitor electrode CPE.

It should be noted that, in the embodiment, the pixel structure PX may have a reflective area RA and a transmissive area TA. The pixel structure PX may further include a reflective layer RFL located in the reflective area RA, and the reflective layer RFL overlaps and is electrically connected to the pixel electrode PE. The material of the reflective layer RFL includes, for example, silver, aluminum or other metal materials with high reflectivity, the alloys thereof, or a stacked structure thereof. A portion of the pixel electrode PE overlaps the reflective layer RFL in the reflective area RA, and another portion overlaps the transmissive area TA. FIG. 2 takes an example in which a portion of the pixel electrode PE is located between the reflective layer RFL and the first substrate 100, but the disclosure is not limited thereto. In other embodiments, the reflective layer RFL may be located between the portion of the pixel electrode PE and the first substrate 100, and the reflective layer RFL and the pixel electrode PE are electrically connected to each other. From another perspective, the reflective area RA of the pixel structure PX is provided with the reflective layer RFL to reflect light, and the transmissive area TA of the pixel structure PX is provided with the pixel electrode PE (i.e., a light-transmissive electrode) to allow light to pass through.

When the display panel 10 displays images, the reflective layer RFL located in the reflective area RA can reflect ambient light AL to form reflected light REL for displaying corresponding images. Under low ambient light conditions, a backlight module (not shown in FIG. 2, which can be disposed on a side of the first substrate 100 facing away from the liquid crystal layer LCL) can be turned on as an auxiliary light source, and the light from the backlight module can pass through the pixel electrode PE located in the transmissive area TA to form transmitted light TL for displaying corresponding images. That is, the display panel 10 of the embodiment may be a transflective display panel.

In the embodiment, the scan line SL, the gate electrode GE and the common electrode CE may be formed in a metal layer ML1 (i.e., the metal layer ML1 may include the scan line SL, the gate electrode GE and the common electrode CE), and the data line DL, the source electrode SE, the drain electrode DE and the capacitor electrode CPE may be formed in a metal layer ML2 (i.e., the metal layer ML2 may include the data line DL, the source electrode SE, the drain electrode DE and the capacitor electrode CPE), but the disclosure is not limited thereto. Furthermore, the display panel 10 may further include a first passivation layer 121, a second passivation layer 122 and an insulation layer 130. The first passivation layer 121 is disposed between the capacitor electrode CPE (or the metal layer ML2) and the insulation layer 130, and covers the capacitor electrode CPE and the source electrode SE and the drain electrode DE of the active device T. The insulation layer 130 is disposed between the first passivation layer 121 and the second passivation layer 122. The insulation layer 130 may serve as a planarization layer to reduce the unevenness of the film layer disposed between the insulation layer 130 and the first substrate 100.

The insulation layer 130 is, for example, an organic insulation layer, and its material may include polyester, polyolefin, polyacryl, polycarbonate, polyalkylene oxide, polystyrene, polyether, polyketone, polyalcohol, polyaldehyde, or other suitable materials, or combinations thereof. Therefore, to prevent delamination between the insulation layer 130 and the metal layer ML2 including the source electrode SE and the drain electrode DE of the active device T, the data line DL and the capacitor electrode CPE, the first passivation layer 121 is further disposed between the insulation layer 130 and the metal film layer (e.g., the metal layer ML2) thereunder in the embodiment. The first passivation layer 121 is, for example, an inorganic insulation layer, and its material may include silicon nitride, silicon oxide, aluminum oxide or other suitable insulating materials.

The pixel electrode PE is disposed on the insulation layer 130. To further improve the adhesion between the insulation layer 130 and the pixel electrode PE made of transparent conductive material, in the embodiment, the second passivation layer 122 may be further disposed between the pixel electrode PE and the insulation layer 130. The second passivation layer 122 is, for example, an inorganic insulation layer, and its material may include silicon nitride, silicon oxide, aluminum oxide or other suitable insulating materials. However, the disclosure is not limited thereto. In other embodiments, the display panel may not be provided with the second passivation layer 122. In the embodiment, the insulation layer 130 has an opening OP overlapping the reflective area RA, and the first passivation layer 121 and the second passivation layer 122 have a through hole TH overlapping the opening OP of the insulation layer 130 (as shown in FIG. 1). The pixel electrode PE may extend into the opening OP of the insulation layer 130 and electrically contact a portion of the capacitor electrode CPE exposed by the through hole TH of the first passivation layer 121 and the second passivation layer 122.

Furthermore, the display panel 10 may further include a color filter layer 210, an insulation layer 220 and a common electrode layer CEL disposed on the second substrate 200. The insulation layer 220 is located between the second substrate 200 and the liquid crystal layer LCL. The insulation layer 220 covers the color filter layer 210. In the embodiment, the material of the insulation layer 220 may be similar to the material of the insulation layer 130, but the disclosure is not limited thereto. The common electrode layer CEL is disposed between the insulation layer 220 and the liquid crystal layer LCL. That is, the insulation layer 220 is located between the common electrode layer CEL and the second substrate 200. In other embodiments not shown, the common electrode layer CEL may be disposed on the first substrate 100 and located between the first substrate 100 and the liquid crystal layer LCL. The common electrode layer CEL overlaps the reflective area RA and the transmissive area TA. The material of the common electrode layer CEL may include a transparent conductive material, which may include, for example, a metal oxide (e.g., indium tin oxide, indium zinc oxide, aluminum tin oxide, aluminum zinc oxide, or other suitable oxides, or a stacked layer of at least two thereof), but the disclosure is not limited thereto. For example, an electric field formed between the pixel electrode PE and the common electrode layer CEL can control the orientation of liquid crystal molecules (not shown) in the liquid crystal layer LCL to display corresponding images. In the embodiment, the common electrode layer CEL and the common electrode CE may receive a common voltage, but the disclosure is not limited thereto.

It is particularly noted that, in the embodiment, the insulation layer 220 on the second substrate 200 has a groove GV located in the transmissive area TA. Therefore, the liquid crystal layer LCL may have different thicknesses in the transmissive area TA and the reflection area RA. For example, the liquid crystal layer LCL has a first portion LCLp1 overlapping the groove GV and a second portion LCLp2 overlapping the reflective layer RFL. The first portion LCLp1 and the second portion LCLp2 of the liquid crystal layer LCL have a first thickness t1 and a second thickness t2 respectively along a stacking direction (e.g., direction Z) of the first substrate 100 and the second substrate 200, wherein the first thickness t1 is greater than the second thickness t2. Preferably, a ratio of the first thickness t1 to the second thickness t2 may be 2.

The light in the reflective area passes through the liquid crystal layer twice from entering to exiting the reflective area whereas the light in the transmissive area TA only passes through the liquid crystal layer LCL once. To avoid significant difference between the optical path of light traveling through the liquid crystal layer LCL in the reflective area RA and the optical path of light traveling through the liquid crystal layer LCL in the transmissive area TA, the groove GV of the insulation layer 220 is designed such that the first thickness t1 of the liquid crystal layer LCL in the transmissive area TA is greater than the second thickness t2 of the liquid crystal layer LCL in the reflective area RA, thereby increasing the optical path of light in the first portion LCLp1 of the liquid crystal layer LCL. As a result, the difference between the optical path of light traveling through the liquid crystal layer LCL in the reflective area RA and the optical path of light traveling through the liquid crystal layer LCL in the transmissive area TA can be effectively reduced (for example, the optical path of light traveling through the liquid crystal layer LCL in the reflective area RA may be the same as the optical path of light traveling through the liquid crystal layer LCL in the transmissive area TA), which helps to improve the consistency of the display performance of the display panel 10 in the reflective area RA and the transmissive area TA.

From another perspective, the insulation layer 220 includes a first insulation portion 220p1 located in the transmissive area TA and a second insulation portion 220p2 located in the reflection area RA. The first insulation portion 220p1 and the second insulation portion 220p2 have a first insulation thickness 220t1 and a second insulation thickness 220t2 along the direction Z, respectively, and the second insulation thickness 220t2 is greater than the first insulation thickness 220t1. In the embodiment, the groove GV of the insulation layer 220 does not penetrate the insulation layer 220, but the disclosure is not limited thereto. In other embodiments not shown, the groove of the insulation layer 220 may penetrate the insulation layer 220.

It is particularly noted that, due to the presence of the groove GV, the insulation layer 220 and the subsequent film layer (e.g., the common electrode layer CEL) formed thereon exhibit more pronounced topographical variation on one side of the liquid crystal layer LCL which may lead to unpredictable alignment of the liquid crystal molecules of the liquid crystal layer LCL near the edge of the groove GV, resulting in light leakage and affecting the dark-state display performance. That is, a light leakage area LKA is formed around the periphery of the transmissive area TA.

To solve the light leakage problem, the display panel 10 may further include a light shielding pattern LSP disposed on the second substrate 200. Specifically, the insulation layer 220 further has a side surface 220ss surrounding and defining the groove GV, and the side surface 220ss of the insulation layer 220 overlaps the light shielding pattern LSP. Preferably, an orthographic projection of the side surface 220ss of the insulation layer 220 on the second substrate 200 is located within an orthographic projection of the light shielding pattern LSP on the second substrate 200. That is, in a normal viewing direction (e.g., direction Z) of the display panel 10, the side surface 220ss of the insulation layer 220 and the light leakage area LKA formed thereby are completely shielded by the light shielding pattern LSP, thereby avoiding dark-state light leakage and helping to improve the display contrast of the display panel 10. In addition, as shown in FIG. 2, the reflective layer RFL in the embodiment may further extend to overlap the side surface 220ss of the insulation layer 220 (i.e., a portion of the reflective layer RFL overlaps the side surface 220ss of the insulation layer 220 and the light leakage area LKA formed thereby) to further shield the light leakage and enhance the contrast. Preferably, the orthographic projection of the side surface 220ss of the insulation layer 220 on the second substrate 200 is located within the orthographic projection of the reflective layer RFL on the second substrate 200.

Other embodiments will be listed below to explain the present disclosure in detail, wherein the same components will be marked with the same symbols, and the description of the same technical content will be omitted. For the omitted parts, please refer to the aforementioned embodiments and will not be repeated below.

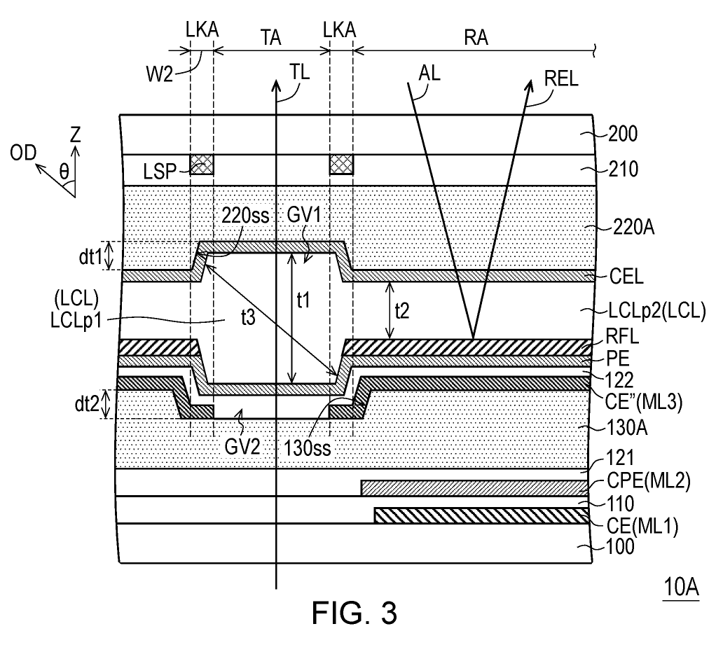

FIG. 3 is a schematic cross-sectional view of a display panel according to another embodiment of the disclosure. Referring to FIG. 3, the main difference between a display panel 10A of the embodiment and the display panel 10 of FIG. 2 lies in that the number of the insulation layers having the grooves is different. Specifically, in the display panel 10A of the embodiment, in addition to the insulation layer 220A on the second substrate 200 having the groove GV1 located in the transmissive area TA, the insulation layer 130A on the first substrate 100 also has a groove GV2 located in the transmissive area TA. The groove GV1 of the insulation layer 220A overlaps the groove GV2 of the insulation layer 130A.

It is particularly noted that the grooves of the insulation layers are provided on opposite sides of the liquid crystal layer LCL of the embodiment, and each of the depths of the two grooves can be less than the depth of the groove GV in FIG. 2, which may also effectively reduce the difference between the optical path of light traveling through the liquid crystal layer LCL in the reflective area RA and the optical path of light traveling through the liquid crystal layer LCL in the transmissive area TA. Therefore, compared with the depth of the groove GV in FIG. 2, the depth of each groove in the embodiment can be further reduced. For example, in the embodiment, the insulation layer 220A and the insulation layer 130A respectively have the groove GV1 and the groove GV2. The liquid crystal layer LCL has a first portion LCLp1 overlapping the groove GV1 and the groove GV2 and a second portion LCLp2 overlapping the reflective layer RFL. The first portion LCLp1 and the second portion LCLp2 of the liquid crystal layer LCL have a first thickness t1 and a second thickness t2 along the direction Z, respectively, wherein the first thickness t1 is greater than the second thickness t2. Preferably, a ratio of the first thickness t1 to the second thickness t2 may be 2. As shown in FIG. 3, through the configuration of the two grooves GV1 and GV2, a portion of the first portion LCLp1 (or referred to as a first sub-portion of the first portion LCLp1) of the liquid crystal layer LCL is higher than the second portion LCLp2 of the liquid crystal layer LCL in the direction Z, and another portion of the first portion LCLp1 (or referred to a second sub-portion of the first portion LCLp1) of the liquid crystal layer LCL is lower than the second portion LCLp2 of the liquid crystal layer LCL in the direction Z. Preferably, a thickness of the first sub-portion of the first portion LCLp1 of the liquid crystal layer LCL may be the same as a thickness of the second sub-portion of the first portion LCLp1.

Due to the presence of the groove GV1, the insulation layer 220A and the subsequent film layers (e.g., the common electrode layer CEL) formed thereon exhibit more pronounced topographical variation on one side of the liquid crystal layer LCL which may lead to unpredictable alignment of the liquid crystal molecules of the liquid crystal layer LCL near the edge of the groove GV1, resulting in light leakage and affecting the dark-state display performance. Due to the presence of the groove GV2, the insulation layer 130A and the subsequent film layers (e.g., a metal layer ML3, the second passivation layer 122 and the pixel electrode PE) formed thereon exhibit more pronounced topographical variation on the other side of the liquid crystal layer LCL which may lead to unpredictable alignment of the liquid crystal molecules of the liquid crystal layer LCL near the edge of the groove GV2, resulting in light leakage and affecting the dark-state display performance. That is, a light leakage area LKA is formed around the periphery of the transmissive area TA. In the embodiment, through the configuration of the grooves GV1 and GV2, the depth of each groove can be further reduced, thereby reducing the area of poor alignment of the liquid crystal layer LCL near the edges of the grooves. That is, a width W2 of the light leakage area LKA caused by provision of the two grooves GV1 and GV2 of the display panel 10A of the embodiment may be smaller than a width W1 of the light leakage area LKA caused by the groove GV of the display panel 10 of FIG. 2. As a result, the area that needs to be shielded by the light shielding pattern LSP can be reduced. To further reduce the width W2 of the light leakage area LKA in FIG. 3, a ratio of the depth dt1 of the groove GV1 to the depth dt2 of the groove GV2 may be greater than or equal to 0.8 and less than or equal to 1.2, but the disclosure is not limited thereto. For example, the depth dt1 of the groove GV1 of the insulation layer 220A may be the same as the depth dt2 of the groove GV2 of the insulation layer 130A (e.g., the depth dt1 of the groove GV1 and the depth dt2 of the groove GV2 may each be half the depth dt of the groove GV in FIG. 2). In addition, in some embodiments, the reduced depth of the groove can further reduce the coating thickness of the insulation layer. In the embodiment, the groove GV1 of the insulation layer 220A does not penetrate the insulation layer 220A, and the groove GV2 of the insulation layer 130A does not penetrate the insulation layer 130A, but the disclosure is not limited thereto. In other embodiments not shown, the groove of the insulation layer 220A may penetrate the insulation layer 220A, and/or the groove of the insulation layer 130A may penetrate the insulation layer 130A.

On the other hand, in the embodiment, the display panel 10A may further include a metal layer ML3 disposed on the first substrate 100 and located between the second passivation layer 122 and the insulation layer 130A. For example, the pixel structure of the embodiment may further include a common electrode CE” formed in the metal layer ML3, wherein each of the capacitor electrode CPE and the pixel electrode PE may be electrically coupled to the common electrode CE” to form an additional storage capacitor. In the embodiment, the common electrode layer CEL, the common electrode CE and the common electrode CE” may receive a common voltage, but the disclosure is not limited thereto.

It is particularly noted that the metal layer ML3 (or the common electrode CE”) may extend from the reflective area RA to the light leakage area LKA to block the light leakage. More specifically, a side surface 130ss of the insulation layer 130A surrounding and defining the groove GV2 may overlap the metal layer ML3. Preferably, an orthographic projection of the side surface 130ss of the insulation layer 130A surrounding and defining the groove GV2 on the first substrate 100 is located within an orthographic projection of the metal layer ML3 on the first substrate 100. In addition, a side surface 220ss of the insulation layer 220A surrounding and defining the groove GV1 may overlap the metal layer ML3. Preferably, an orthographic projection of the side surface 220ss of the insulation layer 220A on the first substrate 100 may be located within the orthographic projection of the metal layer ML3 on the first substrate 100. It is particularly noted that although FIG. 3 illustrates that the second passivation layer 122 overlaps the groove GV2, but the disclosure is not limited thereto. In other embodiments, the portion of the second passivation layer 122 that overlaps the groove GV2 but does not overlap the metal layer ML3 may be removed to adjust the first thickness t1 of the liquid crystal layer LCL.

On the other hand, in the embodiment, the first portion LCLp1 of the liquid crystal layer LCL located in the transmissive area TA has a third thickness t3 overlapping the side surface 220ss of the insulation layer 220A and the side surface 130ss of the insulation layer 130A along an oblique direction OD (i.e., the second direction) deviating from the direction Z (i.e., the first direction), and a ratio of the third thickness t3 to the second thickness t2 can be 2. More specifically, the first thickness t1 of the liquid crystal layer LCL may be the same as the third thickness t3, and a ratio of any one of the first thickness t1 and the third thickness t3 to the second thickness t2 may be 2. The oblique direction OD is neither parallel nor perpendicular to the direction Z. Accordingly, the consistency of the display performance of the display panel 10A in the reflective area RA and the transmissive area TA under an oblique viewing angle can be further improved.

To sum up, in a display panel according to an embodiment of the disclosure, the pixel structure is provided with a reflective area and a transmissive area. Since the insulation layer disposed between the second substrate and the common electrode layer has a groove located in the transmissive area, the thickness of the liquid crystal layer in the transmissive area is greater than the thickness of the liquid crystal layer in the reflective area. Therefore, the difference between the optical path of light traveling through the liquid crystal layer LCL in the reflective area RA and the optical path of light traveling through the liquid crystal layer LCL in the transmissive area TA can be effectively reduced, thereby improving the uniformity of display performance of the display panel in the reflective area and the transmissive area.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. A display panel, comprising:
a first substrate and a second substrate, stacked along a first direction;
a liquid crystal layer, disposed between the first substrate and the second substrate;
a pixel structure, disposed on the first substrate and having a reflective area and a transmissive area, the pixel structure includes:
a reflective layer, located in the reflective area; and
a pixel electrode, located in the transmissive area; and
a first insulation layer, disposed between the liquid crystal layer and the second substrate and having a first groove located in the transmissive area, wherein the liquid crystal layer has a first portion overlapping the first groove and a second portion overlapping the reflective layer, and a first thickness of the first portion along the first direction is greater than a second thickness of the second portion along the first direction.

2. The display panel according to claim 1, wherein a ratio of the first thickness to the second thickness is 2.

3. The display panel according to claim 1, wherein the first insulation layer includes:
a first insulation portion, located in the transmissive area and having a first insulation thickness along the first direction; and
a second insulation portion, located in the reflective area and having a second insulation thickness along the first direction, wherein the second insulation thickness is greater than the first insulation thickness.

4. The display panel according to claim 1, further comprising:
a light shielding pattern, disposed on the second substrate, wherein the first insulation layer further has a side surface surrounding and defining the first groove, and the side surface of the first insulation layer overlaps the light shielding pattern.

5. The display panel according to claim 1, wherein the first insulation layer further has a side surface surrounding and defining the first groove, and the side surface of the first insulation layer overlaps the reflective layer.

6. The display panel according to claim 1, further comprising:
a second insulation layer, disposed between the pixel electrode and the first substrate and having a second groove located in the transmissive area, wherein the first groove overlaps the second groove.

7. The display panel according to claim 6, wherein the first groove and the second groove have a first depth and a second depth respectively, and a ratio of the first depth to the second depth is greater than or equal to 0.8 and less than or equal to 1.2.

8. The display panel according to claim 6, wherein the first insulation layer further has a first side surface surrounding and defining the first groove, the second insulation layer further has a second side surface surrounding and defining the second groove, the first portion of the liquid crystal layer has a third thickness overlapping the first side surface and the second side surface along a second direction, the second direction is not parallel to and not perpendicular to the first direction, and a ratio of the third thickness to the second thickness is 2.

9. The display panel according to claim 6, further comprising:
a metal layer, disposed on the first substrate, wherein the second insulation layer further has a side surface surrounding and defining the second groove, and the side surface of the second insulation layer overlaps the metal layer.

10. The display panel according to claim 1, wherein the pixel electrode is also located in the reflective area, and the pixel electrode overlaps the reflective layer and is electrically connected to the reflective layer.
